(19) United States
(12) Patent Application Publication
(10) Pub. No.: US 2025/0154966 A1
(43) Pub. Date: May 15, 2025

(54) TANK SYSTEM AND VALVE ARRANGEMENT

(71) Applicant: LEINEMANN GMBH & CO. KG, Braunschweig (DE)

(72) Inventor: Ralf KOSMEHL, Lehrte (DE)

(21) Appl. No.: 18/926,528

(22) Filed: Oct. 25, 2024

(30) Foreign Application Priority Data
Oct. 27, 2023 (DE) 10 2023 129 727.9

(51) Int. Cl. F15B 13/042

(52) U.S. Cl. CPC F15B 13/0426; F15B 2215/30

(57) ABSTRACT

A tank system has a tank and a valve arrangement with a pilot-controlled relief valve. The relief valve has a main valve chamber, a filling line, a pilot and a control line. The main valve chamber is connected to the filling line and can be filled with a filling medium via the line. The control line is connected to the tank and the pilot in such a way that the pilot opens when a pressure in the control line exceeds a predetermined response pressure, which causes the relief valve to open. The valve arrangement has a reservoir filled with a flushing medium and is configured to direct the flushing medium at a flushing pressure into the control line and/or into the filling line.

### FIELD OF THE INVENTION

The invention relates to a tank system comprising a tank and a valve arrangement with a pilot-controlled relief valve, the relief valve having a main valve chamber, a filling line, a pilot and a control line, wherein the main valve chamber is connected to the filling line and can be filled with a filling medium via said line and wherein the control line is connected to the tank and the pilot in such a way that the pilot opens when the pressure in the control line exceeds a predetermined response pressure, which causes the relief valve to open. The invention also relates to a valve arrangement for such a tank system.

### BACKGROUND

Tank systems of the type described above and such valve arrangements have been known in the prior art for many years. Such tank systems are used, for example, to store large quantities of oil or gas, and for storing chemicals in a liquid or gaseous form. The filling and emptying process, but also differences in temperature, can lead to the expansion of the medium stored in the tank of the tank system, causing the pressure inside the tank to increase. The pressure should be prevented from becoming so high that it causes damage to the tank and the medium contained within escapes into the surrounding environment in an uncontrolled manner.

In this situation, in order to be able to reduce the pressure inside the tank in a controlled manner, the valve arrangement with the relief valve is used. The actual relief valve has an inlet, which is connected to the tank, and an outlet, which can be connected to a pipeline through which a medium leaving the tank through the relief valve can be discharged. When the relief valve is closed, a passage in the relief valve between the inlet and the outlet is sealed by a valve disk of the relief valve, which rests against a valve seat of the relief valve such that it has a sealing effect.

The valve disk preferably has two sections, each of which is preferably designed in the form of a disk. When the relief valve is closed, the first of these section rests against the valve seat, thereby separating a high-pressure side, which faces the inside of the tank and to which the pressure from the inside of the tank is applied, from a low-pressure side, which faces the outlet of the relief valve. The second section of the valve disk is connected to the first section by a rod or a pin, for example, and seals an opening between the outlet of the relief valve and the main valve chamber when the relief valve is closed. In other embodiments, it is connected to a membrane for the purpose of actuation. The main valve chamber and the two sections of the valve disk are arranged in such a way that the valve disk has to be displaced towards the main valve chamber in order to open the relief valve. This means that the first section has to be moved towards the low-pressure side and thus against the force resulting from the pressure difference.

The main valve chamber is filled with a filling medium through the filling line. Said medium is usually the medium stored in the tank, so that the pressure in the main valve chamber is preferably the same as in the tank. This means that the pressure difference between the high-pressure side and the low-pressure side is identical for both sections of the valve disk. In each case, the low-pressure side is formed by the outlet of the relief valve. In this first section of the valve disk, the high-pressure side is formed by the inside of the tank and by the main valve chamber in the second section of the valve chamber, both of which are at the same pressure.

Preferably, the surface of the second section of the valve disk to which pressure is applied is greater than the surface of the first section of the valve disk to which pressure is applied, meaning that the valve disk is pushed into the closed position by the resulting force.

The pilot, which is also referred to as a pilot valve, is a separate valve that has a force device which comprises, for example, an elastic element, such as a spring, or a magnetic element. The pilot has a pilot chamber that is connected to the control line. The pressure in the control line, which is connected to the inside of the tank, is the same as the pressure inside the tank. The pilot opens when a pressure difference between the atmospheric pressure (atmosphere) and the pressure in the control line exceeds the response pressure, so that the force generated by the force device is overcome. Opening the pilot relieves the main valve chamber, so that the pressure difference between the high-pressure side and the low-pressure side of the section section of the valve disk is reduced and is preferably zero. The entire valve disk is then displaced into the open position due to the pressure difference on the first section of the valve disk and the relief valve opened.

The disadvantage is that contaminations and re-sublimation, for example of sulphur, may occur in the filling line, which contains medium coming from inside the tank for the purpose of transmitting the pressure and filling the main valve chamber. This impedes the functioning of the valve and can even cause blockages. In the case of low-boiling gaseous media that are stored in the tank and with which the main valve chamber is filled, it may also cause condensation of the medium in the main valve chamber. Due to the resulting increased density of the medium, it becomes considerably more difficult to expel the medium from the main valve chamber when the valve is opened.

### SUMMARY

The invention aims to eliminate or at least reduce these disadvantages.

The invention solves the addressed task by way of a tank system of the type described above, which is characterized in that the valve arrangement comprises a reservoir filled with a flushing medium, wherein the valve arrangement is configured to direct the flushing medium at a flushing pressure into the filling line and/or into the control line, the flushing pressure being lower than the response pressure.

The filling line connects the reservoir to the main valve chamber. As a result, the main valve chamber can be filled with the flushing medium, for example compressed air or nitrogen, which prevents condensation of the medium with which the main valve chamber is filled. The flushing medium is preferably a gas, such as air or nitrogen, or the medium stored in the tank.

The flushing pressure can take on different values in the filling line and the control line. For example, the flushing pressure in the control line is greater than the real tank pressure, i.e. the pressure inside the tank of the tank system. This means that the control line can actually be flushed by the flushing medium. The tank of the tank system has a maximum tank working pressure that can or may prevail in the tank before measures must be taken against a further increase in pressure. Preferably, the flushing pressure in the control line is selected in such a way that it is greater than the maximum tank operating pressure. The flushing pressure in the control line is preferably selected in such a way that it is lower than the response pressure at which the pilot opens. This prevents the pilot and therefore also the relief valve from accidentally opening due to the flushing pressure acting on the flushing medium.

The flushing pressure in the filling line is preferably greater than the real tank pressure, i.e. the pressure inside the tank of the tank system. This means that the filling line can actually be flushed by the flushing medium. The tank of the tank system has a maximum tank working pressure that can or may prevail in the tank before measures must be taken against a further increase in pressure. Preferably, the flushing pressure in the filling line is selected in such a way that it is greater than the maximum tank operating pressure. The flushing pressure in the filling line is not capped by the response pressure of the pilot. The flushing pressure in the filling line is preferably greater than the response pressure. The greater the flushing pressure in the filling line, the greater the prevailing pressure in the main valve chamber and thus the force acting on the second section of the valve disk. Since the flushing pressure is preferably greater than the real tank pressure acting on the first section of the valve disk, this embodiment ensures a greater closing force and therefore a particularly secure and therefore also particularly tightly closed relief valve. The flushing pressure in the filling line is capped by the stability of the components subjected to the flushing pressure.

Preferably, the flushing pressure is at least 90%, preferably at least 93%, particularly preferably at least 96% of the response pressure.

The reservoir preferably has a sealed container, such as a pressure vessel, a container or a tank, in which the flushing medium is stored at a storage pressure. The storage pressure is preferably higher than the flushing pressure, so that preferably as much flushing medium as possible is stored in the reservoir. Alternatively or additionally, the reservoir comprises at least one replenishment line, by means of which the flushing medium is supplied, preferably continuously. The reservoir is preferably connected to the filling line via a flushing line. This is particularly practical when the filling line connects the tank to the main valve chamber. In this case, the main valve chamber can be filled with both the flushing medium and the medium from the tank. Preferably a valve, such as a switch valve, is provided that allows switching between the two options.

Alternatively or additionally, the reservoir is connected to the filling line via a flushing line and the filling line to the control line via a connecting line, wherein a return valve is preferably arranged in the connecting line, said return valve allowing a flow from the filling line into the control line and preventing a return flow from the control line into the filling line. Due to this arrangement, the main valve chamber is filled with the flushing medium and is therefore at the flushing pressure, irrespective of the pressure inside the tank. If the flushing pressure is higher than the internal pressure of the tank, this arrangement ensures a higher closing force because a pressure difference between the atmosphere and the internal tank pressure acts on the first section of the valve disk in the direction of the open position and a greater pressure difference between the atmosphere and the flushing pressure acts on the second section of the valve disk in the direction of the closed position. In addition, flushing medium is introduced through the connecting line into the control line, thereby also flushing the control line.

The control line preferably connects the inside of the tank to the pilot. Preferably, the control line is connected between these two ends of the control line to a flushing line, through which the flushing medium can be introduced into the control line. This connection point is preferably situated as far as possible in the direction of the pilot valve, preferably less than 20 cm, particularly preferably less than 10 cm, most preferably less than 5 cm from the pilot.

The flushing medium is introduced into the control line at a flushing pressure. Said flushing pressure is preferably only slightly lower than the response pressure. Therefore, it is usually greater than the prevailing pressure in the tank. In these cases, therefore, the medium in the control line is pushed out of the control line by the flushing medium and into the tank. The flushing pressure then prevails in the control line, which on the one hand is greater than the inner tank pressure, so that the control line is at least flushed by the flushing medium in the section between the point at which the flushing medium is introduced into the control line and the tank. This means that the flushing medium in this section flows through the control line rather than staying there, as in the prior art. This prevents or at least reduces adhesions, contaminations and re-sublimations. On the other hand, the prevailing flushing pressure is lower than the response pressure of the pilot, thus preventing an accidental opening of the pilot and therefore of the relief valve.

If the pressure inside the tank rises to a value that is greater than the flushing pressure, the medium in the tank is pushed into the control line. This inner tank pressure then prevails in the control line. If this pressure exceeds the response pressure, the pilot opens as it does in the prior art, thereby relieving the main valve chamber and opening the relief valve. As long as the inner tank pressure is greater than the flushing pressure, the control line is not flushed; rather the medium contained therein remains in the control line.

To ensure that this is only the case for as briefly as possible, the flushing pressure is preferably only slightly lower than the response pressure.

In one preferable embodiment, the reservoir is connected to the control line via a flushing line. The flushing medium is directed into the control line through said flushing line. A return valve, also known as a one-way valve, is preferably arranged in the flushing line. It allows a flow of flushing medium from the reservoir into the control line and prevents a return flow from the control line into the reservoir.

Preferably, the surfaces of the first section of the valve disk and of the second section of the valve disk to which pressure is applied are selected in such a way that, even if the inner tank pressure is greater than the flushing pressure, but lower than the response pressure, a sufficiently large closing force acts on the valve disk to keep the relief valve securely closed.

The filling line preferably comprises a valve, which can be brought into a first state and a second state. If the valve is in the first state, the main valve chamber can be filled with the flushing medium. If the valve is in the second state, the main valve chamber can be filled with the medium located inside the tank. This valve thus renders it possible to switch between filling from the reservoir and filling from the tank. This is particularly advantageous when a closed volume is used as a reservoir which has to be replaced or refilled. The valve is preferably pre-loaded in the direction of the second state. A spring, for example, is provided for this purpose.

In one preferred embodiment, the valve arrangement has a pressure relief device that reduces the pressure of the flushing medium to the flushing pressure. The pressure relief device is preferably arranged in the connecting line, the flushing line or the filling line. In one particularly preferable embodiment, the valve arrangement comprises multiple pressure relief devices. Particularly preferably, a first pressure relief device is provided which is arranged, for example, in the flushing line or the filling line and which determines the size of the flushing pressure in the filling line and therefore also in the main valve chamber. A further pressure relief device is preferably provided which is arranged, for example, in the control line, particularly preferably in the connecting line, and determines the flushing pressure in the control line. This allows the flushing pressure in the filling line and the flushing pressure in the control line to be separated and individually adjusted. Preferably, the flushing pressure in the control line is lower than the flushing pressure in the filling line.

In addition, the invention solves the task addressed by way of a valve arrangement for a tank system of the type described here. The valve arrangement comprises a pilot-controlled relief valve with a main valve chamber, a filling line, a pilot and a control line, and a reservoir filled with a flushing medium; it is configured to direct the flushing medium into the filling line at a flushing pressure, the flushing pressure being lower than the response pressure.

### DESCRIPTION OF THE DRAWINGS

In the following, a number of embodiment examples of the invention will be explained in more detail with the aid of the accompanying figures. They show:

FIG. 1—a schematic representation of a part of a tank system according to the prior art, and

FIGS. 2 to 15—schematic representations of tank systems according to different embodiment examples of the present invention.

### DETAILED DESCRIPTION

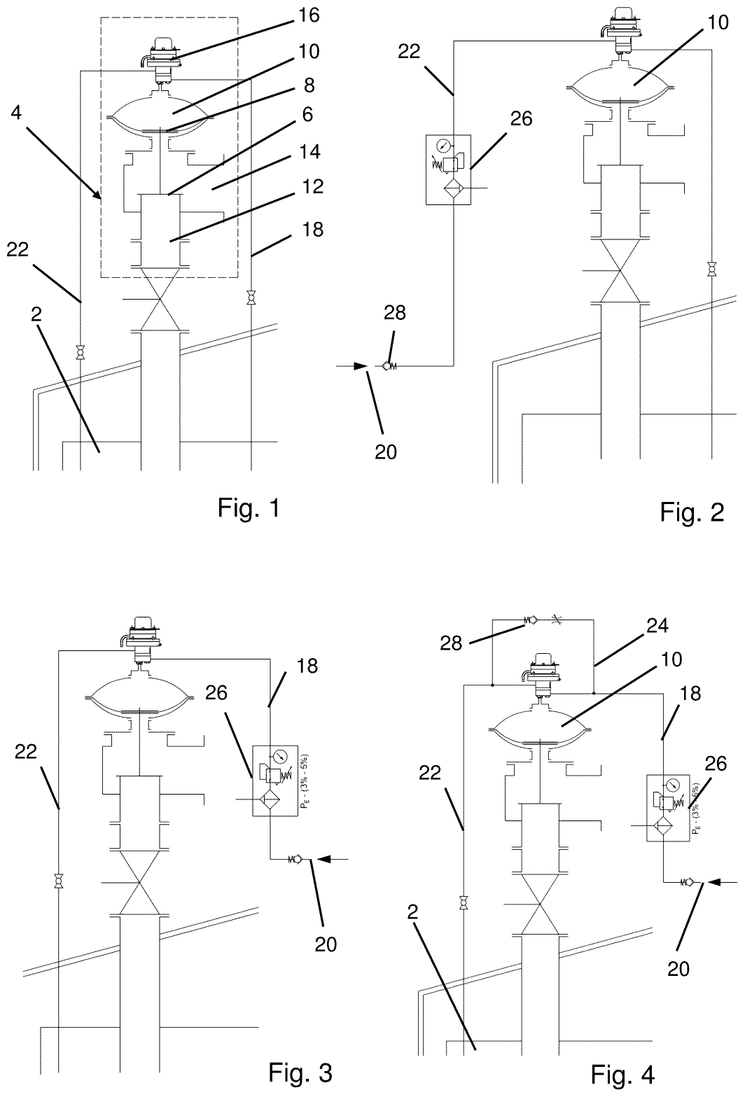

FIG. 1 shows a section of a tank system according to the prior art. It comprises a tank 2, which is depicted as being double-walled in the embodiment example shown, and a valve arrangement with a relief valve 4. The relief valve 4 has a valve disk, which comprises a first section 6 and a second section 8. The first section 6 is arranged between an inlet 12 of the relief valve 4 and an outlet 14 of the relief valve 4. In the closed state shown, the section section 8 separates the outlet 14 of the relief valve 4 from its main valve chamber 10. The pilot 16 is depicted above the main valve chamber 10.

A control line 18 connects the pilot 16 to the tank 2 and transmits the prevailing pressure in the tank 2 to the pilot 16. The tank system also comprises a filling line 22 that connects the tank 2 to the main valve chamber 10. If the pressure in the tank 2 exceeds a predetermined response pressure, the pilot 16 opens and the main valve chamber 10 is relieved, i.e. the pressure inside the main valve chamber 10 drops to the atmospheric pressure outside of the system. This causes the relief valve to open and the valve disk with the first section 6 and the second section 8 is displaced into the open position.

FIG. 2 depicts an embodiment of a tank system according to a first embodiment example of the present invention. Unlike the system from the prior art, the filling line 22 is not connected to the tank 2, but to a reservoir 20 which, in the embodiment example shown, is designed as a supply line. Via this reservoir 20, the system is supplied with a filling medium through a return valve 28, said filling medium being introduced into the filling line 22. A pressure relief device 26 is located in the filling line 22, by means of which the pressure of the filling medium flowing from the reservoir 20 is reduced to a flushing pressure, which is lower than the response pressure of the valve. In the embodiment example shown, the flushing pressure is 3% to 5% lower than the response pressure. In this embodiment, the filling medium flowing from the reservoir 20 is introduced into the main valve chamber 10.

FIG. 3 shows another embodiment. In this case, the reservoir 20 is not connected to the filling line 22, but to the control line 18. In the embodiment example shown, the pressure relief device 26 is located in said control line, by means of which the pressure of the filling medium flowing from the reservoir 20 is reduced to the flushing pressure, which is lower than the response pressure.

In FIG. 4, the embodiment from FIG. 3 has been supplemented by a connecting line 24, by way of which the control line 18 is connected to the filling line 22. The medium flowing from the reservoir 20, the pressure of which is reduced by the pressure relief device 26, can flow from the control line 18, through the connecting line 24 and into the filling line 22, thereby filling the main valve chamber 10. To prevent medium flowing from the tank 2, which is connected to the filling line 22, into the control line 18, a return valve 28 is arranged in the connecting line 24.

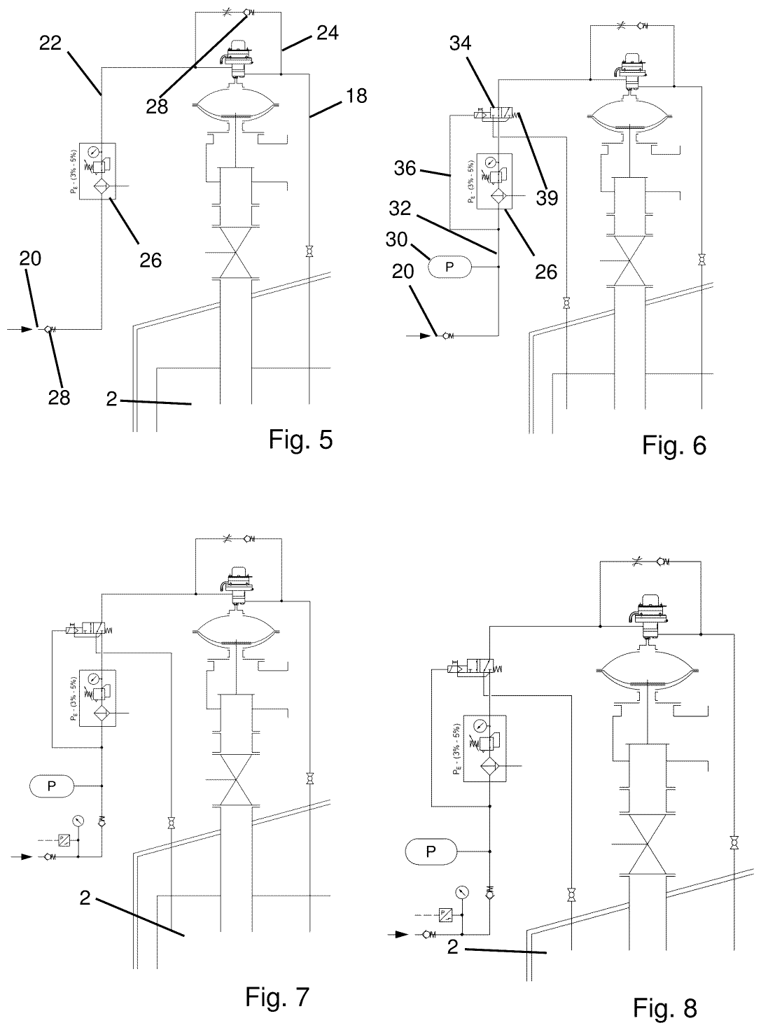

FIG. 5 depicts a further embodiment in which the reservoir 20 is again connected to the flushing line 22. As shown in FIG. 4, the connecting line 24 connects the filling line 22 to the control line 18. The return valve 28 is once again positioned in the connecting line 24, whereby said return valve acts in the opposite direction to FIG. 4. In FIG. 4, the return valve 28 enables a flow from the control line 18 into the filling line 22 and prevents the flow in the opposite direction. In FIG. 5, the return valve 28 enables a flow from the filling line 22 into the control line 18 and prevents the flow in the opposite direction. In this embodiment, the medium flowing from the reservoir 20 fills the main valve chamber 10 on the one hand and flushes the control line 18 on the other, provided that the prevailing pressure in the tank 2 is lower than the flushing pressure set by the pressure relief device 26.

If the pressure in the tank 2 is lower than the flushing pressure, the flushing medium is directed from a reservoir 20, designed here as a supply line, via the filling line 22 and a connecting line 24 into the control line 18. The flushing medium passes through a pressure relief device 26, in which the flushing medium is brought to a flushing pressure. The return valve 28 is located in the connecting line 24, the former enabling a flow from the filling line into the control line 18 (from left to right in FIG. 5) and preventing it in the opposite direction.

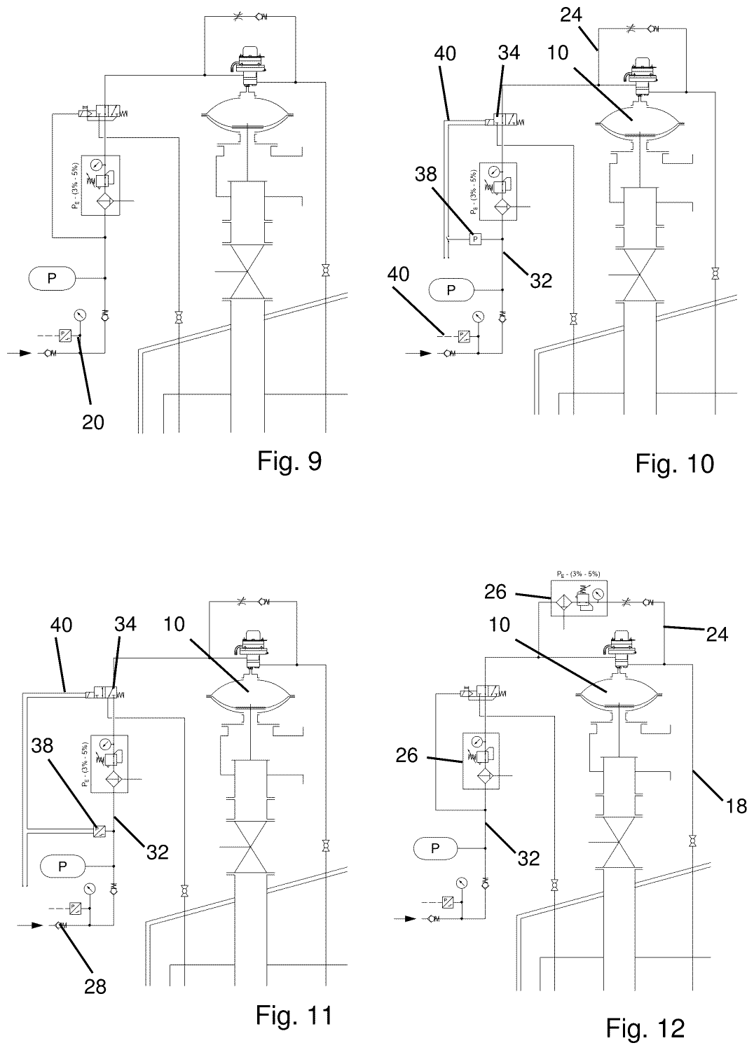

FIG. 6 depicts another embodiment. In addition to the supply line, the reservoir 20 is now also designed as a sealed container 30. In addition to the control line 18, the connecting line 24 and the filling line 22 which, unlike in FIG. 5, connects the pilot 16 to the tank 2, the embodiment in FIG. 6 comprises a flushing line 32, in which the pressure relief device 26 is arranged. FIG. 6 depicts also a valve 34, which is shown in a first state. In this state, the flushing line 32 is connected to the upper part of the filling line 22 via the valve 34, so that the main valve chamber 10 can be filled with the flushing medium from the reservoir 20. The valve 34 is held in this first state via the switch line 36 by the pressure prevailing in the reservoir 20. One can see a spring 39, which pre-loads the valve 34 in the direction of a second state, not depicted. When the pressure drops in the switch line 36 and the resulting force is smaller than the force applied by the spring 39, the valve 34 is moved into the second state, in which the main valve chamber 10 can be filled with the medium from the tank 2. This situation is shown in FIGS. 7 and 8. These two representations only differ in the design of the tank 2, which in FIG. 7 is shown as a double-walled tank and in FIG. 8 as single-walled tank. In addition to the representation from FIG. 6, FIG. 9 shows a further embodiment of the reservoir 20.

FIG. 10 illustrates that the flushing line 32 is equipped with a pressure sensor 38, by way of which the pressure within the flushing line 32 can be determined. The signals generated by the pressure sensor 38 are used to control the valve 34, which is depicted in the first state in FIG. 10, by way of the electrical lines 40 shown, so that the main valve chamber 10 is flushed with the flushing medium. The reverse situation is illustrated in FIG. 11. The signals of the sensor 38 mean that the valve 34 is in the second position, so that the main valve chamber 10 is filled with the medium from the tank.

A further pressure relief device 26 is depicted in the connecting line 24 in FIG. 12. The pressure of the medium flowing through the flushing line 32 is reduced by the first pressure relief device 26, located in the flushing line 32, to a first pressure, which is lower than the response pressure. The main valve chamber 10 is filled at this pressure. It may make sense not to use this pressure to flush the control line 18, but to use the flushing pressure for this instead. The second pressure relief device 26 is therefore provided in the connecting line 24, which brings the medium flowing through the connecting line 24 to the desired flushing pressure.

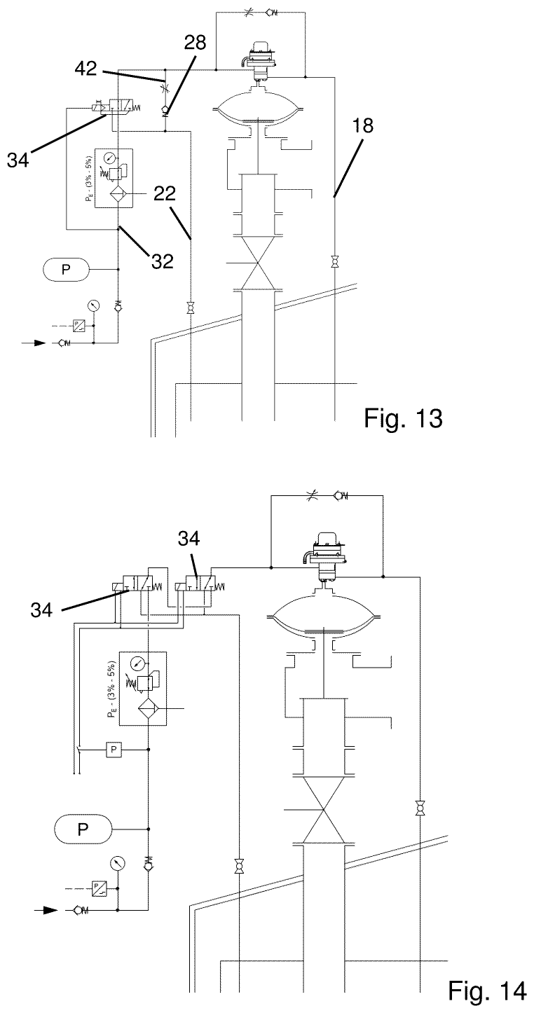

FIG. 13 depicts a backflush line 42, in which a further return valve 28 is located. Medium flowing through the flushing line 32 and the valve 34 into the filling line 22 is also directed through said backflush line 42 into the tank, so that this part of the filling line 22 can also be flushed. In FIG. 14, two valves 34 are connected in series to increase the redundancy and thus the safety of the system.

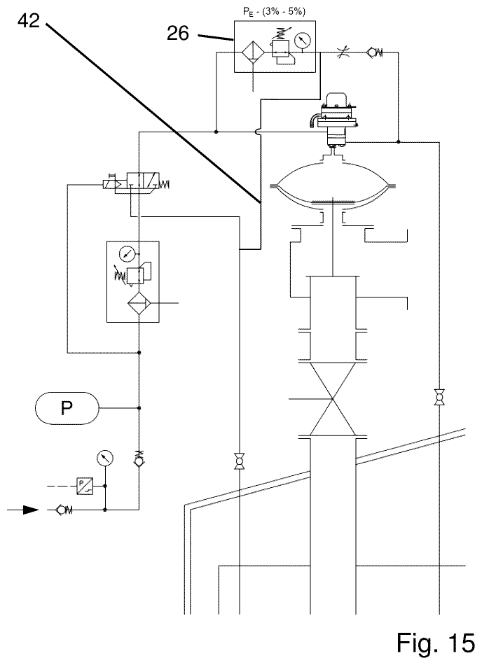

FIG. 15 corresponds to the representation from FIG. 12, in which the backflush line 42 is also provided. The flushing pressure generated by the second pressure relief device 26 prevails in said backflush line, said flushing pressure also being prevalent in the control line.

### REFERENCE LIST

2 tank
4 relief valve
6 first section
8 second section
10 main valve chamber
12 inlet
14 outlet
16 pilot
18 control line
20 reservoir
22 filling line
24 connecting line
26 pressure relief device
28 return valve
30 container
32 flushing line
34 valve
36 switch line
38 pressure sensor
39 spring
40 electrical line
42 backflush line

1. A tank system, comprising:
a tank; and
a valve arrangement with a reservoir and a pilot-controlled relief valve, wherein the pilot-controlled relief valve comprises
a main valve chamber,
a filling line,
a pilot, and
a control line,
wherein the main valve chamber is connected to the filling line and is fillable with a filling medium via the filling line, and
wherein the control line is connected to the tank and the pilot such that the pilot opens when a pressure in the control line exceeds a predetermined response pressure,
wherein the reservoir is fillable or filled with a flushing medium, and
wherein the valve arrangement is configured to direct the flushing medium at a flushing pressure into the control line and/or into the filling line.

2. The tank system according to claim 1, wherein the flushing pressure in the control line when the flushing medium is directed therein is lower than the predetermined response pressure.

3. The tank system according to claim 2 wherein the flushing pressure is at least 90 of the predetermined response pressure.

4. The tank system according to claim 1 wherein the flushing pressure in the filling line when the flushing medium is directed therein is greater than the predetermined response pressure.

5. The tank system according to claim 1, further comprising a control unit that is configured to control the flushing pressure in the filling line and/or in the control line such that the flushing pressure is greater than a pressure inside the tank by a predetermined value.

6. The tank system according to claim 1 wherein the reservoir is connected to the filling line via a flushing line.

7. The tank system according to claim 1 wherein the filling line is connected to the control line via a connecting line, wherein a return valve is arranged in the connecting line that only enables a flow from the filling line into the control line.

8. The tank system according to claim 7, wherein the filling line comprises a valve which is configured to permit in a first state, the main valve chamber is fillable with flushing medium, and in a second state, the main valve chamber is fillable with a medium located in the tank.

9. The tank system according to claim 1 wherein the valve arrangement comprises a pressure relief device that is configured to reduce a pressure of the flushing medium to a flushing pressure.

10. A valve arrangement for a tank system according to claim 1 comprising a pilot-controlled relief valve with a main valve chamber, a filling line, a pilot, a control line, and a reservoir fillable with a flushing medium, and wherein the valve arrangement is configured to direct the flushing medium into the control line at a flushing pressure, the flushing pressure being lower than the predetermined response pressure.
